(19) United States
(12) Patent Application Publication
(10) Pub. No.: US 2026/0228485 A1
(43) Pub. Date: Aug. 6, 2026

(54) SEMANTIC MATCHING FOR RULE CONFLICT IDENTIFICATION

(71) Applicant: Wells Fargo Bank, N.A., San Francisco, CA (US)

(72) Inventors: Anantjot S. Anand, Edina, MN (US); Balaji Gopalakrishnan, Charlotte, NC (US); Johnson Le, Chandler, AZ (US); Donald W. Putz, Lacona, IA (US); Supriyo Sarkar, Bengaluru (IN); Gauri Tomar, Bengaluru (IN); Jonathon S. Van't Hul, Waukee, IA (US); Jacob Fredric White, Frisco, TX (US)

(21) Appl. No.: 19/409,404

(22) Filed: Dec. 4, 2025

Related U.S. Application Data
(60) Provisional application No. 63/754,219, filed on Feb. 5, 2025.

(51) Int. Cl. G06N 3/042; G06F 40/30; G06F 40/40; G06N 3/045

(52) U.S. Cl. CPC G06N 3/042; G06F 40/30; G06F 40/40; G06N 3/045

(57) ABSTRACT

System and techniques for identifying conflicts between rules in a rule engine using semantic matching are described herein. A user-provided rule, conforming to a specified rule standard, is obtained via a user interface. A corresponding vector embedding is generated by translating the rule into a high-dimensional representation reflecting its semantic properties. This embedding is then used to search for a set of similar rules in a rule repository, enabling rapid detection of potential conflicts or redundancies. The resulting similar rules are displayed to the user for review prior to installing the new rule, thus improving the consistency and reliability of rule-based systems.

### CROSS-REFERENCE TO RELATED APPLICATION

This application claims priority to U.S. Provisional Patent Application Ser. No. 63/754,219, filed on Feb. 5, 2025, which is incorporated herein by reference in its entirety.

### TECHNICAL FIELD

Embodiments described herein generally relate to database querying and more specifically to semantic matching for rule conflict identification.

### BACKGROUND

A rule engine is a component configured to execute, manage, or enforce rules within a system by separating business logic (e.g., a target or goal) from application code. A rule engine evaluates rules, typically expressed as conditional statements (e.g., “if-then-else” statements), and applies the conditional statements to incoming data or events to determine outcomes, actions, or decisions. Rule engines are generally built around the concept of a knowledge base containing declarative rules and an inference engine that interprets and applies those rules Rule engines often use pattern-matching algorithms, such as the Rete algorithm, to optimize the evaluation of complex rule sets against large datasets. Rule engines have been employed in domains like business process management, expert systems, fraud detection, and decision automation, enabling non-technical users to modify rules without altering underlying application code. By enabling high configurability, scalability, or rapid updates, rule engines streamline decision-making processes while maintaining system flexibility and reducing development overhead.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment including a system for semantic matching for rule conflict identification, according to an embodiment.

FIG. 2 illustrates an example flow for identifying a rule conflict upon rule entry, according to an embodiment.

FIG. 3 illustrates an example flow for performing a natural language search for a rule, according to an embodiment.

FIG. 4 illustrates a flow diagram of an example of a method for semantic matching for rule conflict identification, according to an embodiment.

FIG. 5 is a block diagram illustrating an example of a machine upon which one or more embodiments may be implemented.

### DETAILED DESCRIPTION

A rule conflict in the context of a rule engine occurs when multiple rules within the system are triggered by the same input or event but prescribe conflicting actions or outcomes. Rule conflicts typically arise due to overlapping conditions, contradictory logic, or poorly defined rule priorities. For example, one rule may permit an action while another rule prohibits the same action under similar conditions, leading to ambiguity in execution. Rule conflicts can disrupt decision-making processes and compromise the integrity of the system.

As the number of applications, users, and rules increases, rule conflict and other issues (e.g., rule supplication) can also increase, leading to increasing issues in managing the rules. Rule authors can unintentionally create duplicate rules or write rules that are very similar to existing ones. Duplicates result in wasted effort, while near-duplicates can introduce conflicts or produce unpredictable outcomes in the system. Rule conflict resolution strategies can include priority-based resolution, where rules are assigned precedence levels; specificity resolution, where more specific rules override general ones; or tie-breaking logic, where conflicts are handled through pre-defined heuristics or manual intervention. However, these strategies do not address ever increasing rules that burden rule management. Nor do these strategies address the existence of a superseded rule that will be implemented if the rule superseding it is modified or removed. Such situations can again lead to unforeseen consequences to the operation of the rule engine.

To address these issues, a vector embedding of rules can be used to compare proposed rules to existing rules using vector search techniques, such as indexing in a vector database. This comparison can then be used, for example, to prevent a rule from being entered, or to provide a warning to a rule author of the possible duplication or conflict present in the proposed rule. For example, when a rule author creates a new rule, similar or related rules can be presented to the rule author based on the semantic comparison. Thus, the author is able to determine whether a new rule is necessary, whether the new rule should be modified, or if an existing rule can be edited to achieve the intended outcome. In an example, the system can support natural language querying, enabling users to find relevant rules intuitively.

The system described herein provides a human interface to a domain-specific ecosystem. For example, the rules engine can use a logic engine to translates rules—which are expressed in first-order predicate calculus—into user-friendly English descriptions. These descriptions provide clarity and help authors navigate and understand the logical structure of the rules, including metadata such as attributes and database table references. However, the strict logic-engine expressions can be difficult to search or can be directed to different audiences than the rule author. By using the semantic space provided by vector embeddings, the system provides an intuitive interface to the rule descriptions provided by the rules engine. This situation also enables enhancements to the general Large Language Model (LLM) artificial intelligence (AI) models used for vector embeddings. Specifically, domain-specific training enhances the effectiveness of the AI model, which is generally not trained on a given domain. By combining domain-specific semantic search, natural language interfaces, and clear English descriptions of complex logical rules, the issues of duplication and conflict can be resolved along with significant improvements to usability and efficiency in rule authoring. Additional details and examples are provided below.

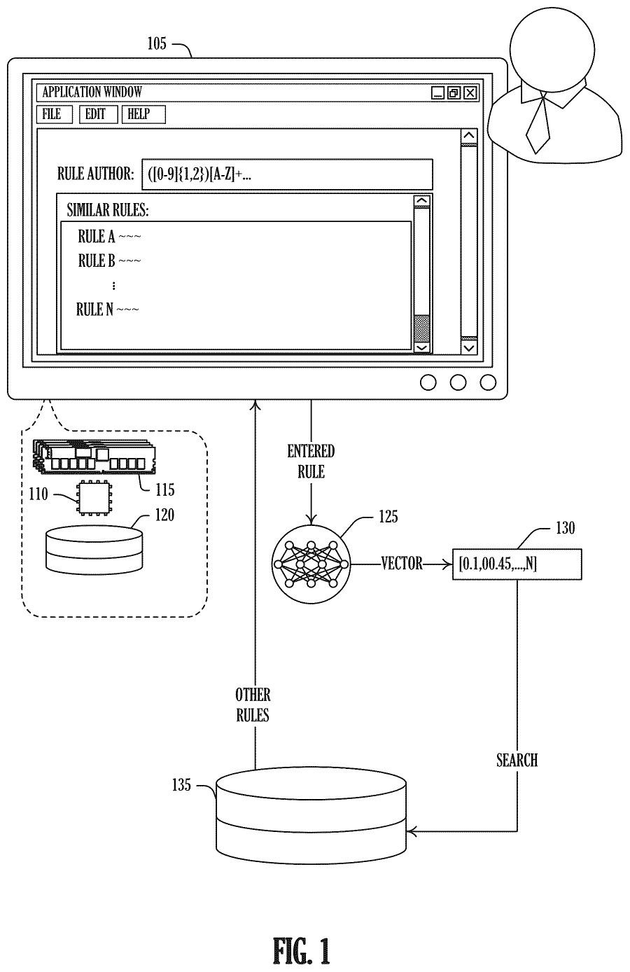

FIG. 1 is a block diagram of an example of an environment including a system 105 for semantic matching for rule conflict identification, according to an embodiment. The system 105 includes processing circuitry 110, storage 120 (e.g., power-stable storage such as a hard drive, solid state drive, etc.), and memory 115. The memory 115 is generally used to maintain running state information for the system 105 that is usually discarded between system power cycles or restarts. The memory 115 and the storage 120 are both forms of computer readable media. The processing circuitry 110—or software residing in the memory 115 or storage 120 executing on the processing circuitry 110—configure the system 105 to perform various operations when in running.

The system 105 includes, or is connected to another device, to provide a user interface to the user. The system 105 can include, or be connected to, a data structure 135 (e.g., a knowledge base) to store rules that can be used, for example, by an inference engine to implemented (e.g., execute) the rules stored therein. When in operation, the user (e.g., rule author) enters some or all of a proposed rule into the user interface. Thus, the processing circuitry 110 is configured to obtain (e.g., retrieve, receive, etc.) a rule entered by the user via the user interface. In an example, the user interface is an application or web-based graphical user interface (GUI) that enables the typing of the rule or rule elements (e.g., conditions, data sources, context elements, etc.), the selection of rule elements (e.g., giving drop down selections, dialogs, etc.), or other GUI conventions to build rules. In an example, the rule conforms to a rule standard for a rule engine. This example specifies that the GUI or the resultant rule conforms to valid rules in the rule engine. Such conformance can be obtained through restrictive UI elements—including limited selections from menus—or via validation (e.g., a non-conforming rule cannot progress in the UI).

In an example, the rule corresponds to a context. Here, the context is information not explicit in the rule that defines an environment (e.g., equipment, location, time, personal, etc.) in which the rule operates. For example, the UI can include one or more selections to define to what area (e.g., organizational unit, product, etc.) the rule applies (e.g., supply chain, human resources, etc.) or to what data sources, actions, or processes the rule applies.

In an example, the context includes a path. The path can define a resource—such as a database, website, etc.—or an organizational unit (e.g., a division of a company). Often, paths have a hierarchy (a sequence of steps or a broader to more narrow classification) that provides variable scoping of contextual components. For example, if the path is a filesystem path, portions of the path towards a root of the file system (e.g., directories closer to the root) can be the same for different files and provide clues to contextual similarity between these different files. Other examples of paths can include a Javascript Object Notation (JSON) or eXtensible Markup Language (XML) path.

In an example, the context includes a target. Here, the target refers to one or more components upon which the rule acts. For example, if the target is an employee record, and the rule defines the operations to add a new employee, the employee record is created based on the action of the rule. The identification of targets enables an ability to detect rule conflicts based on modifying the same target.

In an example, the context includes a set of parameters. In an example, the context includes a set of actions. Although parameters could apply to aspects of a rule that are not actions—such as a timeout—generally, the parameters modify actions for a particular invocation. For example, an authentication action could include the parameters of a username and password or the like. Often, actions and parameters often operate together to modify the target. Using the employee record example from above, an action could include an insert into an employee database table and the parameters include the data being inserted.

The processing circuitry 110 is configured to generate a vector embedding 130 based on the rule. The vector embedding 130 is a data structure that encodes semantic mean. Generally, the vector embedding 130 is a vector (e.g., an array of values) where vector components represent a dimension in a semantic space and have a numerical value. Accordingly, in an example, the vector embedding 130 is a vector of values that correspond to a semantic space.

Typically, the vector embedding 130 is a mathematical representation of data in a continuous, multi-dimensional space where each data point is represented as a vector of real numbers. These embeddings are often generated through machine learning (e.g., AI) models and are designed to capture the underlying structure, relationships, or semantic meaning of the input data. The semantic space is usually a geometric space where the positions of vectors encode meaningful relationships between data points. For example, in natural language processing, embeddings such as word embeddings map words into a semantic space where semantically similar words (e.g., “king” and “queen”) are located closer together, while unrelated words (e.g., “king” and “car”) are farther apart.

Semantic spaces enable models to generalize complex relationships, such as analogies, by leveraging geometric properties like vector arithmetic. For example, in a well-structured semantic space, the relationship “king-man+woman≈queen” emerges naturally from the learned representations. This property makes embeddings useful for tasks like search, recommendation systems, or clustering. The design and dimensionality of a semantic space, along with the methods used to generate embeddings, such as Word2Vec, GloVe, or transformer-based architectures, influence the quality of the representation. Semantic spaces are not limited to text data.

In an example, generating the vector based on the rule includes providing a context that corresponds to the rule as input to a generator of the vector embedding 130. Here, the processing circuitry 110 is configured to include more than just the rule entered by the user to generate the embedding. Thus, a rule that includes an action such as “insert record” isn't merely being matched to every other record insert, but rather the target, the path, or other contextual aspects that practically change the effect of the rule are combined in the resultant vector embedding 130. In an example, the context can be used as a repository resource for retrieval augmented generation (RAG) of the vector. Here, the individual elements of the context can themselves be vectorized to identify which are relevant to the rule. Then, these specific context elements are provided as input tokens, along with the rule, to produce the final vector.

In an example, generating the vector embedding 130 based on the rule includes invoking a machine learning model 125 to produce the vector embedding 130. In an example, the machine learning model 125 is implemented with a transformer architecture. In an example, the machine learning model is a Large Language Model (LLM) trained on a general human language that is not specific to the rule engine. LLMs are AI models generally trained on large amounts of data (e.g., text data) to perform a wide range of language tasks, such as text generation, translation, summarization, or question answering. An implementation of LLMs uses a transformer architecture, which is a neural network design built on the concept of self-attention, which enables the model to dynamically focus on different parts (e.g., tokens) of an input sequence when making predictions. This mechanism captures long-range dependencies and contextual relationships in text more effectively than other architectures like recursive neural networks (RNNs) or long-short term memory (LSTM) models.

In a transformer-based LLM, input text is tokenized and converted into embeddings, which are then processed through multiple stacked transformer layers. A layer includes a multi-head self-attention mechanism and position-wise feedforward networks, combined with residual connections or layer normalization to enhance training stability. Model capacity is determined by its parameters, such as the number of layers, attention heads, or embedding dimensions. For example, some models use a transformer decoder architecture with autoregressive generation, predicting the next token in a sequence based on previously generated tokens.

In an example, generating the vector embedding 130 based on the rule includes creating a human language description for the rule and using the human language description as input to generate the vector embedding 130. In an example, a rules-based language transformer is invoked to create the human language description. These examples reflect the earlier discussion with a logic engine generating the human language description of the rule.

The processing circuitry 110 is configured to perform (or cause to be performed) a search for a set of similar rules based on the vector embedding 130. In an example, searching for the set of similar rules includes using the vector embedding 130 as input to a search of a vector database (e.g., the data structure 135) that includes corresponding vector embeddings for records in the vector database. In an example, the corresponding vector embeddings are generated from a human language description of a rule corresponding to a record.

A vector database is a database configured to efficiently store, index, and query high-dimensional vector embeddings. Unlike traditional databases that rely on exact-match or range-based queries, vector databases generally support a similarity search that enables rapid retrieval of data points that are semantically or structurally similar to a given query vector. A variety of similarity search techniquues can be used, such as k-Nearest Neighbor (k-NN) search, which finds the vectors most similar to a given query vector using distance metrics such as Euclidean distance (L2) or Cosine similarity. A vector database may also support Approximate Nearest Neighbor (ANN) search, which trades off a small amount of accuracy for much faster query times and relies on algorithms like Hierarchical Navigable Small World (HNSW), Product Quantization (PQ), or Inverted File (IVF). Range or radius search is another option, retrieving all vectors within a given distance threshold from a query vector. In addition to purely vector-based searches, a vector database can provide hybrid (vector+keyword) search, which combines semantic similarity from embeddings with traditional keyword or metadata filters, enabling more complex queries. Multimodal search is also supported by some platforms, storing embeddings from different data types (text, images, audio, and video) and enabling, for example, text-based queries to find relevant images. Filtered vector search further extends the possibilities by applying metadata or Boolean filters in conjunction with vector-based retrieval, as in scenarios like “find the closest vectors within a certain genre.” A vector database can also provide hybrid ranking or reranking features, refining results after an initial similarity-based retrieval with textual relevance, user preferences, or other ranking signals. Vector databases typically use indexing techniques such as tree-based methods (e.g., KD-trees), graph-based methods (e.g., Hierarchical Navigable Small World graphs (HNSW)), or partitioning-based methods (e.g., Locality Sensitive Hashing (LSH)) to optimize search speed and memory usage in high-dimensional spaces.

In an example, searching for the set of similar rules includes selecting rules for the set of similar rules with a comparison metric between the vector embedding 130 and a candidate rule vector embedding 130 that meets a threshold. In an example, the comparison metric is a Euclidian distance. In an example, the comparison metric is a cosine distance. In an example, the comparison metric is a dot product.

The processing circuitry 110 is configured to display (or cause to be displayed) the set of similar rules on the user interface for review by the user prior to installing the rule. This aspect of rule review enables the user to quickly review already existing rules to detect duplication or rule conflicts.

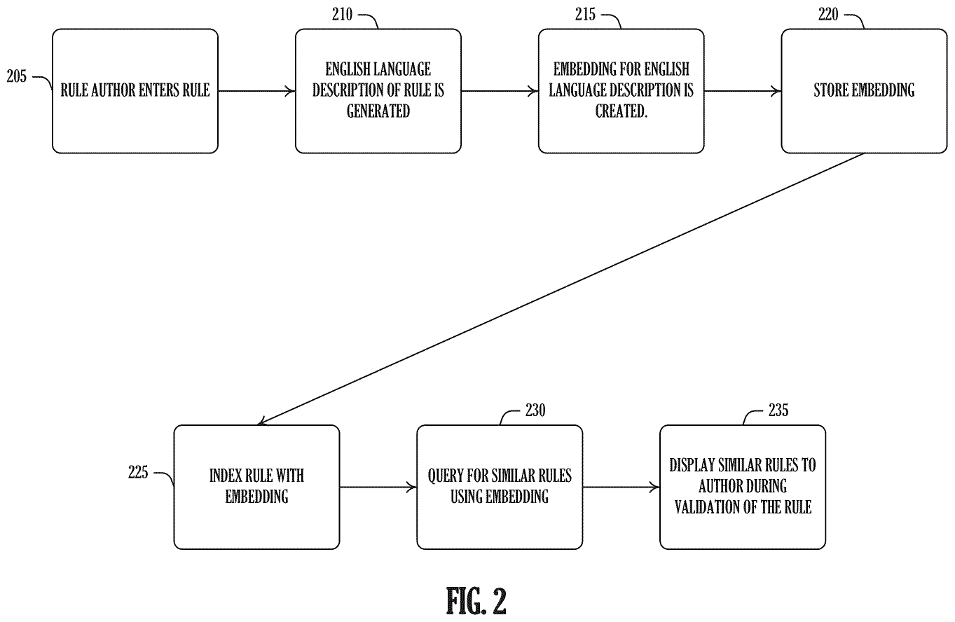

FIG. 2 illustrates an example flow for identifying a rule conflict upon rule entry, according to an embodiment. At operation 205, the rule author enters (e.g., saves, types, etc.) a rule. At operation 210, a logic engine of the rule engine generates a natural language (e.g., English, French, German, Chinese, Japanese, etc.) description of the rule. At operation 215, the rule engine generates a vector embedding of the rule. At operation 220, this embedding can be stored for later use (e.g., in future searching operations when stored in a vector database or to perform a query of existing rules). At operation 225, the generated embedding is used as an index for the rule, such as in a vector database.

At operation 230, the generated vector embedding is used to find similar rules in the rule store (e.g., knowledge base, vector database, etc.). At operation 235, these similar rules can be displayed to the user to enable rule conflict or duplication detection. The display of similar rules can include a description as to why the similar rules are similar, and, for example, an alert if a logical overlap is detected. In an example, the display of the similar rules occurs during a validation phase of rule entry.

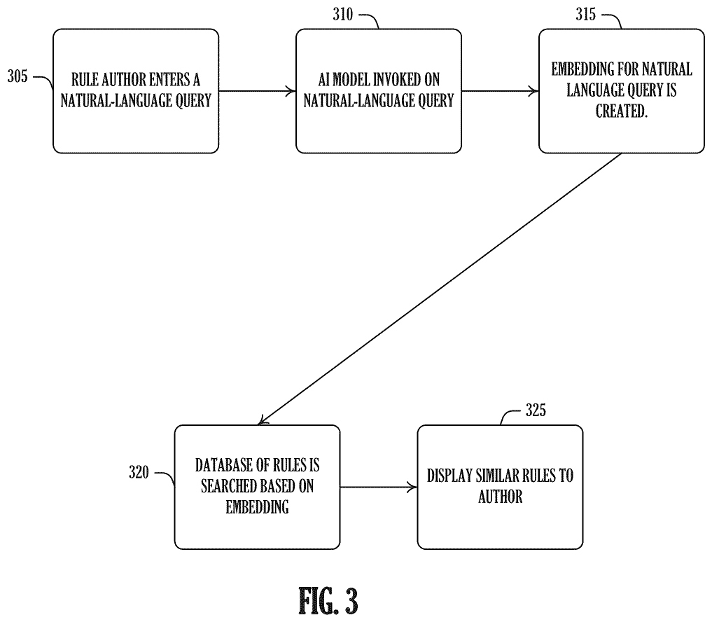

FIG. 3 illustrates an example flow for performing a natural language search for a rule, according to an embodiment. At operation 305, the rule engine obtains a natural language query, for example, from a rule author. The rule engine can invoke (e.g., execute) an AI model on the natural language query (operation 310) to produce a vector embedding for the natural language query (operation 315). At operation 320, the database of existing rules is searched using the vector embedding to find, for example, the ten (or other parameter) most similar rules. At operation 35, the similar rules are presented to the rule author.

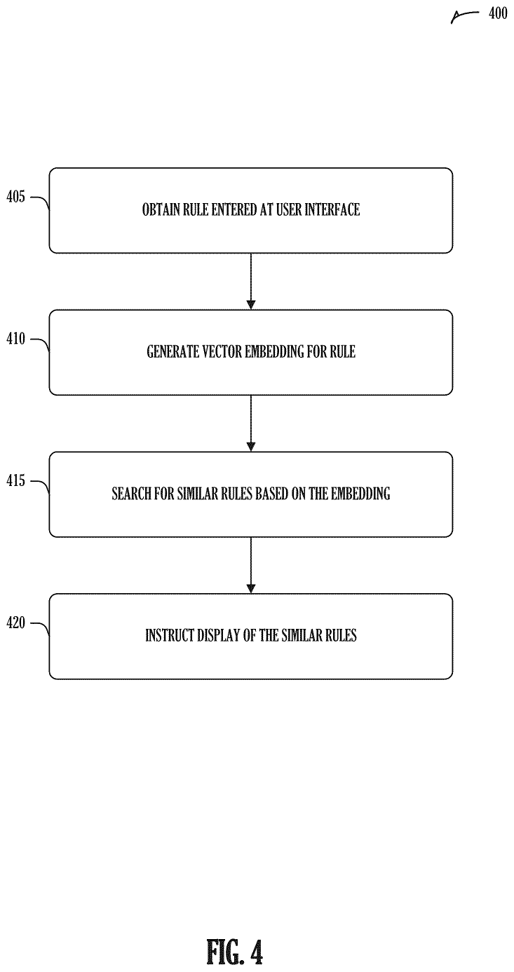

FIG. 4 illustrates a flow diagram of an example of a method 400 for semantic matching for rule conflict identification, according to an embodiment. The operations of the method 400 are performed by computational hardware, such as that described above or below (e.g., processing circuitry).

At operation 405, a rule entered by a user via a user interface is obtained (e.g., retrieved, received, etc.). In an example, the rule conforms to a rule standard for a rule engine. In an example, the rule corresponds to a context. In an example, the context includes a path. In an example, the context includes a target. In an example, the context includes a set of parameters. In an example, the context includes a set of actions.

At operation 410, a vector embedding is generated based on the rule. In an example, the vector embedding is a vector of values that correspond to a semantic space. In an example, generating the vector based on the rule includes providing a context that corresponds to the rule as input to a generator of the vector embedding.

In an example, generating the vector embedding based on the rule includes invoking a machine learning model to produce the vector embedding. In an example, the machine learning model is implemented with a transformer architecture. In an example, the machine learning model is a Large Language Model (LLM) trained on a general human language that is not specific to the rule engine.

In an example, generating the vector embedding based on the rule includes creating a human language description for the rule and using the human language description as input to generate the vector embedding. In an example, a rules-based language transformer is invoked to create the human language description.

At operation 415, a search is performed for a set of similar rules based on the vector embedding. In an example, searching for the set of similar rules includes using the vector embedding as input to a search of a vector database that includes corresponding vector embeddings for records in the vector database. In an example, the corresponding vector embeddings are generated from a human language description of a rule corresponding to a record.

In an example, searching for the set of similar rules includes selecting rules for the set of similar rules with a comparison metric between the vector embedding and a candidate rule vector embedding that meets a threshold. In an example, the comparison metric is a Euclidian distance. In an example, the comparison metric is a cosine distance. In an example, the comparison metric is a dot product.

At operation 420, causing the set of similar rules to be displayed on the user interface for review by the user prior to installing the rule.

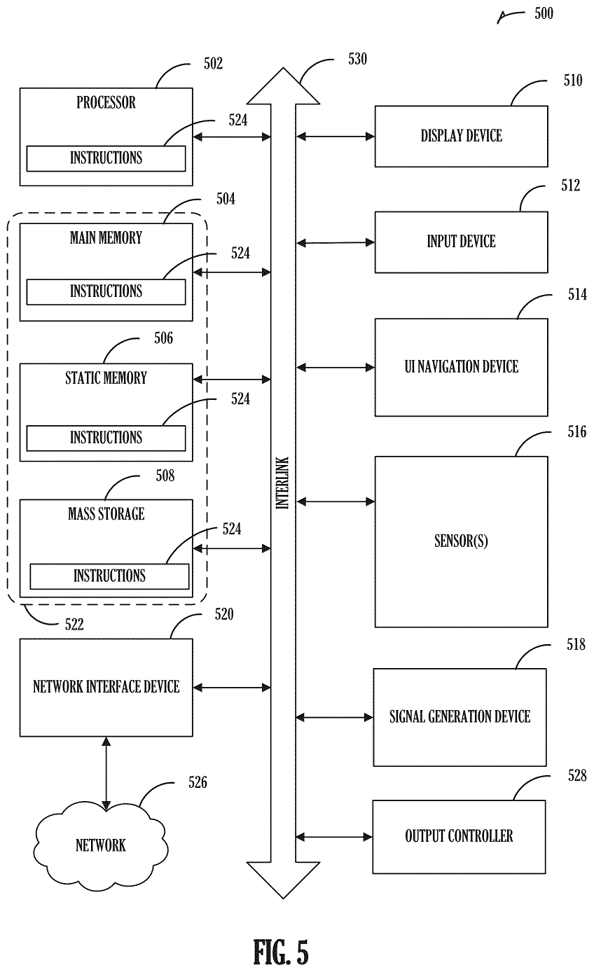

FIG. 5 illustrates a block diagram of an example machine 500 upon which any one or more of the techniques (e.g., methodologies) discussed herein may perform. Examples, as described herein, may include, or may operate by, logic or a number of components, or mechanisms in the machine 500. Circuitry (e.g., processing circuitry) is a collection of circuits implemented in tangible entities of the machine 500 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 500 follow.

In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 500 may include a hardware processor 502 (e.g., a central processing unit (CPU), a graphics processing unit (GPU), a hardware processor core, or any combination thereof), a main memory 504, a static memory (e.g., memory or storage for firmware, microcode, a basic-input-output (BIOS), unified extensible firmware interface (UEFI), etc.) 506, and mass storage 508 (e.g., hard drives, tape drives, flash storage, or other block devices) some or all of which may communicate with each other via an interlink (e.g., bus) 530. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 508, a signal generation device 518 (e.g., a speaker), a network interface device 520, and one or more sensors 516, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 502, the main memory 504, the static memory 506, or the mass storage 508 may be, or include, a machine readable medium 522 on which is stored one or more sets of data structures or instructions 524 (e.g., software) embodying or utilized by any one or more of the techniques or functions described herein. The instructions 524 may also reside, completely or at least partially, within any of registers of the processor 502, the main memory 504, the static memory 506, or the mass storage 508 during execution thereof by the machine 500. In an example, one or any combination of the hardware processor 502, the main memory 504, the static memory 506, or the mass storage 508 may constitute the machine readable media 522. While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 522 may be representative of the instructions 524, such as instructions 524 themselves or a format from which the instructions 524 may be derived. This format from which the instructions 524 may be derived may include source code, encoded instructions (e.g., in compressed or encrypted form), packaged instructions (e.g., split into multiple packages), or the like. The information representative of the instructions 524 in the machine readable medium 522 may be processed by processing circuitry into the instructions to implement any of the operations discussed herein. For example, deriving the instructions 524 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 524.

In an example, the derivation of the instructions 524 may include assembly, compilation, or interpretation of the information (e.g., by the processing circuitry) to create the instructions 524 from some intermediate or preprocessed format provided by the machine readable medium 522. The information, when provided in multiple parts, may be combined, unpacked, and modified to create the instructions 524. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 524 may be further transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 500, and includes digital or analog communications signals or other intangible medium to facilitate communication of such software. A transmission medium is a machine readable medium.

### Additional Notes & Examples

Example 1 is an apparatus for semantic matching for rule conflict identification, the apparatus comprising: a memory including instructions; and processing circuitry that, when in operation, is configured by the instructions to: obtain a rule entered by a user via a user interface, the rule conforming to a rule standard for a rule engine; generate a vector embedding based on the rule, the vector embedding being a vector of values that correspond to a semantic space; search for a set of similar rules based on the vector embedding; and cause the set of similar rules to be displayed on the user interface for review by the user prior to installing the rule.

In Example 2, the subject matter of Example 1, wherein the rule corresponds to a context.

In Example 3, the subject matter of Example 2, wherein the context includes a path, a target, a set of parameters, or a set of actions.

In Example 4, the subject matter of any of Examples 2-3, wherein to generate the vector based on the rule, the processing circuitry is configured to provide the context as input to a generator of the vector embedding.

In Example 5, the subject matter of any of Examples 1-4, wherein to search for the set of similar rules, the processing circuitry is configured to use the vector embedding as input to a search of a vector database that includes corresponding vector embeddings for records in the vector database.

In Example 6, the subject matter of Example 5, wherein the corresponding vector embeddings are generated from a human language description of a rule corresponding to a record.

In Example 7, the subject matter of any of Examples 1-6, wherein to search for the set of similar rules, the processing circuitry is configured to select rules for the set of similar rules with a comparison metric between the vector embedding and a candidate rule vector embedding that meets a threshold.

In Example 8, the subject matter of Example 7, wherein the comparison metric is a Euclidian distance, a cosine distance, or a dot product.

In Example 9, the subject matter of any of Examples 1-8, wherein to generate the vector embedding based on the rule, the processing circuitry is configured to invoke a machine learning model to produce the vector embedding.

In Example 10, the subject matter of Example 9, wherein the machine learning model is implemented with a transformer architecture.

In Example 11, the subject matter of any of Examples 9-10, wherein the machine learning model is a Large Language Model (LLM) trained on a general human language that is not specific to the rule engine.

In Example 12, the subject matter of any of Examples 1-11, wherein to generate the vector embedding based on the rule, the processing circuitry is configured to: create a human language description for the rule; and use the human language description as input to generate the vector embedding.

In Example 13, the subject matter of Example 12, wherein a rules-based language transformer is invoked to create the human language description.

In Example 14, the subject matter of any of Examples 1-13, wherein the processing circuitry is configured to receive an indication from the user to enter the rule.

In Example 15, the subject matter of any of Examples 1-14, wherein the processing circuitry is configured to: receive an identification of a similar rule in the set of similar rules; and load the similar rule in a rule editor to replace the rule.

Example 16 is a method for semantic matching for rule conflict identification, the method comprising: obtaining a rule entered by a user via a user interface, the rule conforming to a rule standard for a rule engine; generating a vector embedding based on the rule, the vector embedding being a vector of values that correspond to a semantic space; searching for a set of similar rules based on the vector embedding; and causing the set of similar rules to be displayed on the user interface for review by the user prior to installing the rule.

In Example 17, the subject matter of Example 16, wherein the rule corresponds to a context.

In Example 18, the subject matter of Example 17, wherein the context includes a path, a target, a set of parameters, or a set of actions.

In Example 19, the subject matter of any of Examples 17-18, wherein generating the vector based on the rule includes providing the context as input to a generator of the vector embedding.

In Example 20, the subject matter of any of Examples 16-19, wherein searching for the set of similar rules includes using the vector embedding as input to a search of a vector database that includes corresponding vector embeddings for records in the vector database.

In Example 21, the subject matter of Example 20, wherein the corresponding vector embeddings are generated from a human language description of a rule corresponding to a record.

In Example 22, the subject matter of any of Examples 16-21, wherein searching for the set of similar rules includes selecting rules for the set of similar rules with a comparison metric between the vector embedding and a candidate rule vector embedding that meets a threshold.

In Example 23, the subject matter of Example 22, wherein the comparison metric is a Euclidian distance, a cosine distance, or a dot product.

In Example 24, the subject matter of any of Examples 16-23, wherein generating the vector embedding based on the rule includes invoking a machine learning model to produce the vector embedding.

In Example 25, the subject matter of Example 24, wherein the machine learning model is implemented with a transformer architecture.

In Example 26, the subject matter of any of Examples 24-25, wherein the machine learning model is a Large Language Model (LLM) trained on a general human language that is not specific to the rule engine.

In Example 27, the subject matter of any of Examples 16-26, wherein generating the vector embedding based on the rule includes: creating a human language description for the rule; and using the human language description as input to generate the vector embedding.

In Example 28, the subject matter of Example 27, wherein a rules-based language transformer is invoked to create the human language description.

In Example 29, the subject matter of any of Examples 16-28, comprising receiving an indication from the user to enter the rule.

In Example 30, the subject matter of any of Examples 16-29, comprising: receiving an identification of a similar rule in the set of similar rules; and loading the similar rule in a rule editor to replace the rule.

Example 31 is a computer readable media including instructions for semantic matching for rule conflict identification, the instructions, when executed by processing circuitry, cause the processing circuitry to perform operations comprising: obtaining a rule entered by a user via a user interface, the rule conforming to a rule standard for a rule engine; generating a vector embedding based on the rule, the vector embedding being a vector of values that correspond to a semantic space; searching for a set of similar rules based on the vector embedding; and causing the set of similar rules to be displayed on the user interface for review by the user prior to installing the rule.

In Example 32, the subject matter of Example 31, wherein the rule corresponds to a context.

In Example 33, the subject matter of Example 32, wherein the context includes a path, a target, a set of parameters, or a set of actions.

In Example 34, the subject matter of any of Examples 32-33, wherein generating the vector based on the rule includes providing the context as input to a generator of the vector embedding.

In Example 35, the subject matter of any of Examples 31-34, wherein searching for the set of similar rules includes using the vector embedding as input to a search of a vector database that includes corresponding vector embeddings for records in the vector database.

In Example 36, the subject matter of Example 35, wherein the corresponding vector embeddings are generated from a human language description of a rule corresponding to a record.

In Example 37, the subject matter of any of Examples 31-36, wherein searching for the set of similar rules includes selecting rules for the set of similar rules with a comparison metric between the vector embedding and a candidate rule vector embedding that meets a threshold.

In Example 38, the subject matter of Example 37, wherein the comparison metric is a Euclidian distance, a cosine distance, or a dot product.

In Example 39, the subject matter of any of Examples 31-38, wherein generating the vector embedding based on the rule includes invoking a machine learning model to produce the vector embedding.

In Example 40, the subject matter of Example 39, wherein the machine learning model is implemented with a transformer architecture.

In Example 41, the subject matter of any of Examples 39-40, wherein the machine learning model is a Large Language Model (LLM) trained on a general human language that is not specific to the rule engine.

In Example 42, the subject matter of any of Examples 31-41, wherein generating the vector embedding based on the rule includes: creating a human language description for the rule; and using the human language description as input to generate the vector embedding.

In Example 43, the subject matter of Example 42, wherein a rules-based language transformer is invoked to create the human language description.

In Example 44, the subject matter of any of Examples 31-43, wherein the operations comprise receiving an indication from the user to enter the rule.

In Example 45, the subject matter of any of Examples 31-44, wherein the operations comprise: receiving an identification of a similar rule in the set of similar rules; and loading the similar rule in a rule editor to replace the rule.

Example 46 is a system for semantic matching for rule conflict identification, the system comprising: means for obtaining a rule entered by a user via a user interface, the rule conforming to a rule standard for a rule engine; means for generating a vector embedding based on the rule, the vector embedding being a vector of values that correspond to a semantic space; means for searching for a set of similar rules based on the vector embedding; and means for causing the set of similar rules to be displayed on the user interface for review by the user prior to installing the rule.

In Example 47, the subject matter of Example 46, wherein the rule corresponds to a context.

In Example 48, the subject matter of Example 47, wherein the context includes a path, a target, a set of parameters, or a set of actions.

In Example 49, the subject matter of any of Examples 47-48, wherein the means for generating the vector based on the rule include means for providing the context as input to a generator of the vector embedding.

In Example 50, the subject matter of any of Examples 46-49, wherein the means for searching for the set of similar rules include means for using the vector embedding as input to a search of a vector database that includes corresponding vector embeddings for records in the vector database.

In Example 51, the subject matter of Example 50, wherein the corresponding vector embeddings are generated from a human language description of a rule corresponding to a record.

In Example 52, the subject matter of any of Examples 46-51, wherein the means for searching for the set of similar rules include means for selecting rules for the set of similar rules with a comparison metric between the vector embedding and a candidate rule vector embedding that meets a threshold.

In Example 53, the subject matter of Example 52, wherein the comparison metric is a Euclidian distance, a cosine distance, or a dot product.

In Example 54, the subject matter of any of Examples 46-53, wherein the means for generating the vector embedding based on the rule include means for invoking a machine learning model to produce the vector embedding.

In Example 55, the subject matter of Example 54, wherein the machine learning model is implemented with a transformer architecture.

In Example 56, the subject matter of any of Examples 54-55, wherein the machine learning model is a Large Language Model (LLM) trained on a general human language that is not specific to the rule engine.

In Example 57, the subject matter of any of Examples 46-56, wherein the means for generating the vector embedding based on the rule include: means for creating a human language description for the rule; and means for using the human language description as input to generate the vector embedding.

In Example 58, the subject matter of Example 57, wherein a rules-based language transformer is invoked to create the human language description.

In Example 59, the subject matter of any of Examples 46-58, comprising means for receiving an indication from the user to enter the rule.

In Example 60, the subject matter of any of Examples 46-59, comprising: means for receiving an identification of a similar rule in the set of similar rules; and means for loading the similar rule in a rule editor to replace the rule.

Example 61 is at least one machine-readable medium including instructions that, when executed by processing circuitry, cause the processing circuitry to perform operations to implement of any of Examples 1-60.

Example 62 is an apparatus comprising means to implement of any of Examples 1-60.

Example 63 is a system to implement of any of Examples 1-60.

Example 64 is a method to implement of any of Examples 1-60.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A non-transitory computer readable media including instructions for semantic
matching for rule conflict identification, the instructions, when executed by processing circuitry, cause the processing circuitry to perform operations comprising:
obtaining a rule entered by a user via a user interface, the rule conforming to a rule standard for a rule engine;
generating a vector embedding based on the rule, the vector embedding being a vector of values that correspond to a semantic space;
searching for a set of similar rules based on the vector embedding; and
causing the set of similar rules to be displayed on the user interface for review by the user prior to installing the rule.

2. The non-transitory computer readable media of claim 1, wherein the rule corresponds to a context.

3. The non-transitory computer readable media of claim 2, wherein the context includes a path, a target, a set of parameters, or a set of actions.

4. The non-transitory computer readable media of claim 2, wherein generating the vector based on the rule includes providing the context as input to a generator of the vector embedding.

5. The non-transitory computer readable media of claim 1, wherein searching for the set of similar rules includes using the vector embedding as input to a search of a vector database that includes corresponding vector embeddings for records in the vector database.

6. The non-transitory computer readable media of claim 5, wherein the corresponding vector embeddings are generated from a human language description of a rule corresponding to a record.

7. The non-transitory computer readable media of claim 1, wherein searching for the set of similar rules includes selecting rules for the set of similar rules with a comparison metric between the vector embedding and a candidate rule vector embedding that meets a threshold.

8. The non-transitory computer readable media of claim 7, wherein the comparison metric is a Euclidian distance, a cosine distance, or a dot product.

9. The non-transitory computer readable media of claim 1, wherein generating the vector embedding based on the rule includes invoking a machine learning model to produce the vector embedding.

10. The non-transitory computer readable media of claim 9, wherein the machine learning model is implemented with a transformer architecture.

11. The non-transitory computer readable media of claim 9, wherein the machine learning model is a Large Language Model (LLM) trained on a general human language that is not specific to the rule engine.

12. The non-transitory computer readable media of claim 1, wherein generating the vector embedding based on the rule includes:
creating a human language description for the rule; and
using the human language description as input to generate the vector embedding.

13. The non-transitory computer readable media of claim 12, wherein a rules-based language transformer is invoked to create the human language description.

14. The non-transitory computer readable media of claim 1, wherein the operations comprise receiving an indication from the user to enter the rule.

15. The non-transitory computer readable media of claim 1, wherein the operations
comprise:
receiving an identification of a similar rule in the set of similar rules; and
loading the similar rule in a rule editor to replace the rule.

16. A method for semantic matching for rule conflict identification, the method
comprising:
obtaining a rule entered by a user via a user interface, the rule conforming to a rule standard for a rule engine;
generating a vector embedding based on the rule, the vector embedding being a vector of values that correspond to a semantic space;
searching for a set of similar rules based on the vector embedding; and
causing the set of similar rules to be displayed on the user interface for review by the user prior to installing the rule.

17. The method of claim 16, wherein the rule corresponds to a context.

18. The method of claim 16, wherein searching for the set of similar rules includes using the vector embedding as input to a search of a vector database that includes corresponding vector embeddings for records in the vector database.

19. The method of claim 16, wherein searching for the set of similar rules includes selecting rules for the set of similar rules with a comparison metric between the vector embedding and a candidate rule vector embedding that meets a threshold.

20. The method of claim 16, wherein generating the vector embedding based on the rule includes invoking a machine learning model to produce the vector embedding.
